(19) United States
(12) Patent Application Publication
(10) Pub. No.: US 2003/0147687 A1
(43) Pub. Date: Aug. 7, 2003

(54) Binding element and method for binding a stack of sheet material

(76) Inventors: Michael Freund, Adelberg (DE); Albert Rieger, Geislingen (DE); Kurt Stehle, Bad Waldsee (DE)

Correspondence Address: Kevin L. Leffel, Heidelberg Digital L.L.C., 2600 Manitou Road, Rochester, NY, 14624, US

(21) Appl. No.: 10/268,850

(22) Filed: Oct. 10, 2002

(30) Foreign Application Priority Data
Oct. 11, 2001 (DE) 101 50 299.0

(51) Int. Cl. B42F 3/00; B42F 13/02

(52) U.S. Cl. 402/8

(57) ABSTRACT

The invention relates to a binding element and method for binding a stack of sheet-shaped print materials through one or more complementary holes extending all the way through. A binding element and method are provided for binding a stack of sheet-shaped print materials. A comb structure having a back rib and at least one strip connected to the back rib is inserted through holes in the stack of sheet-shaped print materials. The comb structure is closed with positive locking in the back rib by the at least one strip.

### BACKGROUND

The invention relates to a binding element and method for binding a stack of sheet-shaped print materials through one or more complementary holes extending all the way through.

Plastic binding elements for loose binding of stacks of punched sheet-shaped print materials that are punched all the way through are known from the state of the art. For example, European patent application EP 0 516 207 discloses a plastic binding element that consists of a rolled plastic comb, in which the comb structure of the plastic binding element is guided through the holes of the series of holes punched all the way through on one side of the stack and overlapped with the brochure back structure of the plastic binding elements so that a loose binding of the individually punched sheet-shaped print materials of the stack can be achieved. The plastic binding element is manufactured of an extruded plastic tube that is slit and from which the comb-like structure is subsequently punched out.

The disadvantage of this and comparable plastic binding elements for binding stacks of punched sheet-shaped print materials is that a later adjustment to the height of a stack of punched sheet-shaped print materials, i.e. the thickness of the brochure to be bound, is not possible. Therefore, separate plastic binding elements must be supplied for different thicknesses of the brochure to be bound. In addition, plastic binding elements of this and comparable types have the disadvantage that the plastic binding element does not close with positive locking and even after the binding process, if there is enough pulling stress, the comb structure can be removed from the holes in the stack of sheets.

### SUMMARY OF THE INVENTION

A binding element and method are provided for binding a stack of sheet-shaped print materials. A comb structure having a back rib and at least one strip connected to the back rib is inserted through holes in the stack of sheet-shaped print materials. The comb structure is closed with positive locking in the back rib by the at least one strip.

### BRIEF DESCRIPTION OF THE DRAWINGS

FIG. 1 presents a perspective view of a plastic binding element according to one aspect of the invention.

FIG. 2 presents a top view of the plastic binding element of FIG. 1 with an enlarged detail.

FIG. 3 presents a cross section through the plastic binding element taken along line B-B of FIG. 2 with two enlarged details.

FIG. 4 presents a top view of a mat for packaging the plastic binding element, according to another aspect of the invention.

FIG. 5 presents a top view of a plastic binding element with a comb structure and a back rib, according to another aspect of the invention.

### DETAILED DESCRIPTION

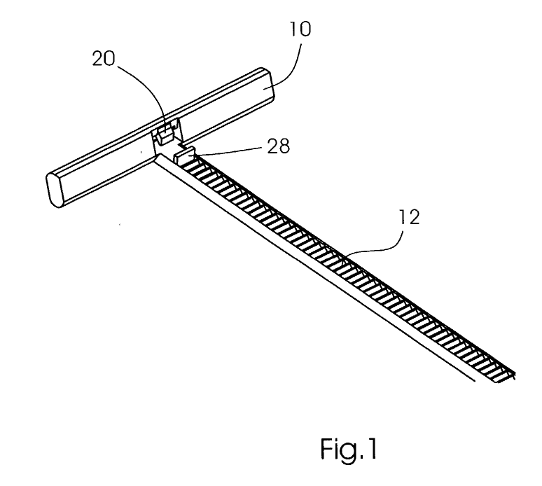

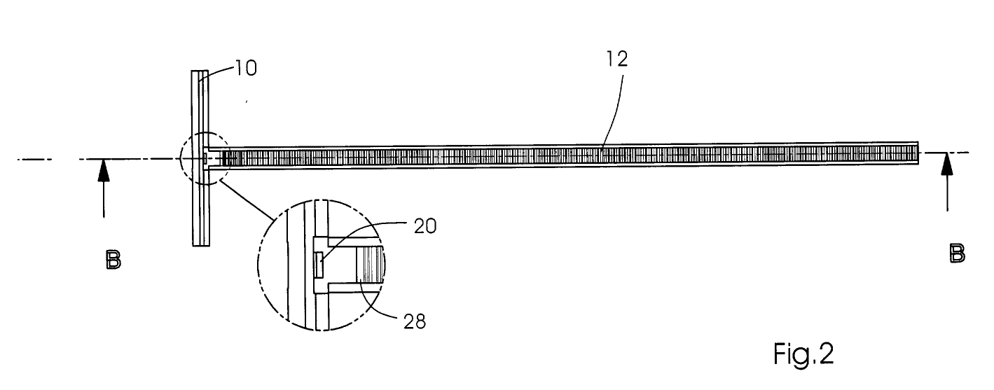

The plastic binding element shown in FIG. 1 to FIG. 3 is a one-piece injection-molded part of plastic. It has a straight back rib 10 with a rectangular cross section with cut-off corners.

In the center of the back rib 10, a toothed strip 12 is arranged that is straight and projects perpendicular from the back rib 10. Back rib 10 and toothed strip 12 form a T. The toothed strip 12 is flatter than the back rib 10. Its underside 14 is flush with the back rib 10 and it is provided with teeth on the upper side 16.

Above the toothed strip 12, the back rib 10 has an insertion opening 18 for it. From above, and into the insert opening 18, a locking tooth 20 formed on the back rib 10 extends that takes up almost the entire width of the insert opening 18.

The toothed strip 12 is elastic. It can be bent into a loop and with the free end first, it can be introduced from the back into the insert opening 18. In this process, its teeth come to rest on top. The locking tooth 20 engages into the teeth as a latch.

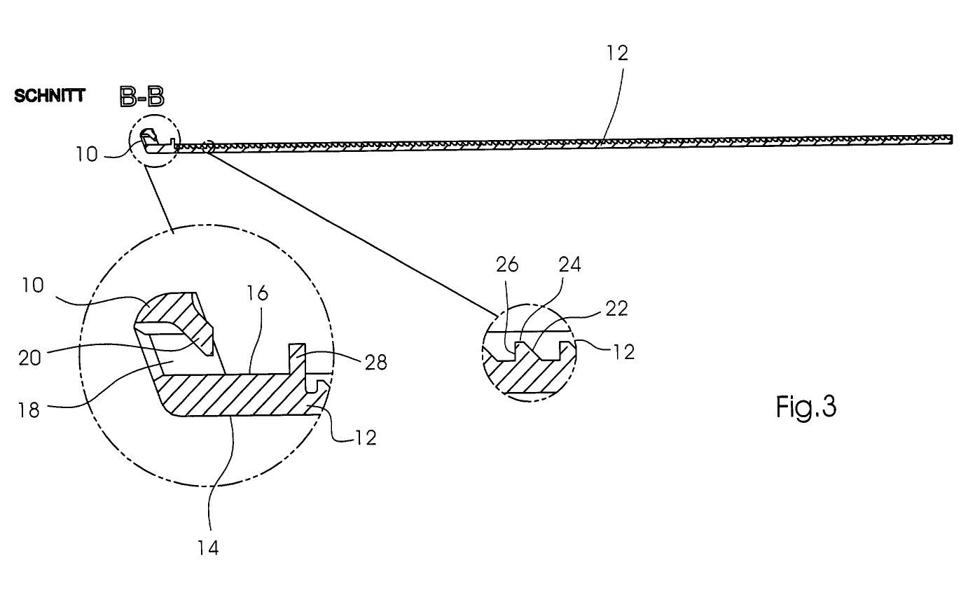

As can best be seen in FIG. 3, in the insertion direction of the toothed strip 12, the teeth have raising ramps 22, level plateaus 24 and vertically falling steps 26. During insertion, the locking tooth 20 is deflected upward elastically against the ramps 22. It slides over the plateaus 24 and falls into the steps 26.

The insertion depth of the toothed strip 12 is limited by a stop 28, which is formed on the toothed strip 12 itself, so that it projects upward in front of the insertion opening 18. The stop 28 is at a distance from the locking tooth 20 that is about twice the distance between the teeth on the toothed strip. The teeth start behind the stop 28.

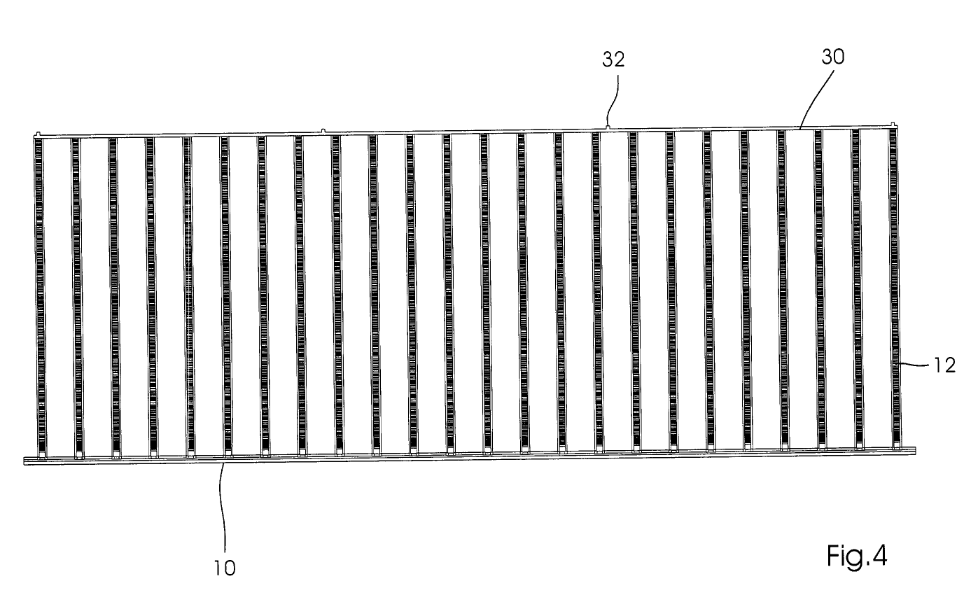

FIG. 4 shows a mat in which a number of parallel toothed strips 12 project from a significantly longer back rib 10. The toothed strips 12 are equidistant. The back rib 10 projects beyond the two outer toothed strips 12.

The ends of toothed strips 12 facing away from the back rib 10 are connected with a magazine rib 30 that extends parallel to the back rib 10. In order to obtain matted or rolled goods that are simple to magazine, the magazine rib 30 is connected by material bridges 32 to an adjacent back rib 10. The material bridges 32 occur during injection molding. They can be separated in order to separate adjacent mats.

Depending on the application, plastic binding elements can be separated from the matted or rolled goods with only one toothed strip 12 or several parallel toothed strips 12. To do this, the back ribs 10 and magazine ribs 30 are separated in the center between the toothed strips 12. Before use, the magazine rib 30 will be cut off and the toothed strip(s) 12 will be cut to size according to the thickness of the sheet stack to be bound.

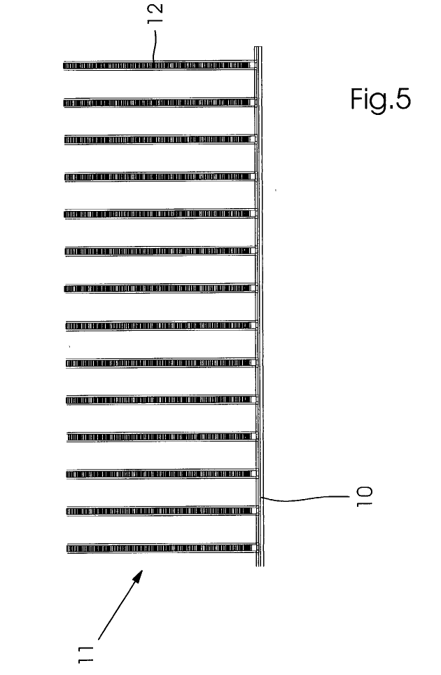

FIG. 5 shows a plastic binding element according to the invention that has a comb structure 11 that has already been coordinated to a corresponding format of punched sheet-shaped print materials having a number of strips 12 that are connected by way of a common back rib 10, whereby the length of the strips 12 is already cut to the required length in order to bind a stack of punched sheet-shaped print materials to a brochure with a specific thickness.

Numerous variations are possible. The plastic binding element may comprise a comb structure consisting of at least one strip and a back rib that holds at least one strip, whereby the comb structure is inserted through holes in the stack of punched sheet-shaped print materials and whereby the plastic binding element can be closed with positive locking in the back rib by means of at least one strip. The positive locking between the strips and the back rib makes a stable binding of the stack of punched sheet-shaped print materials possible. In the case of a comb structure with a number of strips, an especially stable binding and solid brochure results through a positive locking binding.

An adaptation to the stack thickness of the stack of punched sheet-shaped print materials and to the format of the punched sheet-shaped print materials may be carried out right before the binding procedure, especially automatically. This is achieved in that the length of the strips that will be adjusted, with positive locking, into the back rib of the plastic binding element is cut off to the appropriate length right before the binding procedure. A format adjustment advantageously occurs by cutting the comb structure to size so that it contains exactly the same number of strips as the number of holes that are provided in the punched sheet-shaped print materials.

In an especially advantageous design, the strips of the comb structure are designed as toothed strips.

For binding a punched stack of sheets, the toothed strips of the plastic binding element may be cut to a length corresponding to the thickness of the stack. The toothed strips are pushed through the holes in the stack of sheets, wrapped around it and their ends are pushed into the insertion openings of the back ribs where a locking tooth engages the teeth.

Cutting to size and closing the plastic binding element can be carried out automatically. By cutting the toothed strip to size in a suitable way before insertion of the toothed strip into the insertion opening, an adaptation to almost any stack thickness is possible.

The plastic binding element according to the invention is an uncomplicated plastic injection molded part. Its back rib can be designed so that it is so narrow and thin that it practically does not add any bulk to the sheet stack. It is easily possible to insert the back rib in the stack of sheets. In addition, this makes it possible to ensure opening the bound brochure 180°.

The holding force of the locking tooth (teeth) in the teeth is of a magnitude such that the toothed strip(s) does (do) not loosen during normal use.

In a preferred embodiment, the teeth of the toothed strip(s) has (have) ramps that deflect the locking tooth, that are raised in insertion direction with steps behind them, into which the locking tooth falls.

In a preferred embodiment, behind the locking tooth, a stop is provided that limits the insertion depth of the toothed strip. The stop ensures that the plastic binding element can only close in a well-defined length of the toothed strip(s) and its loop(s) cannot be pulled closer.

In a preferred embodiment, the stop is formed on the toothed strip itself.

In a preferred embodiment, the stop is at a distance from the locking tooth that is about twice the distance between the teeth on the toothed strip. This ensures that the toothed strip(s) always engage, no matter what the dimensional tolerances during cutting to size.

In a preferred embodiment, the teeth of the toothed strip start behind the stop.

In a preferred embodiment, the toothed strips project crosswise from the back rib. With more than two toothed strips, these are preferably equidistant.

In a preferred embodiment, the ends of the toothed strip are connected to a magazine rib that is preferably located parallel to the back rib. This gives the ends a good position and they cannot get mixed up in each other. The magazine rib makes the fully automatic handling of the plastic binding element easier. It is cut to size before use, according to the format size of the brochure to be bound, especially adapted to the number of holes comprising the row of holes in the sheet-shaped print materials.

For use in fully automatic binding machines, the plastic binding element is preferably available in the form of mats or rolls that are automatically placed in a magazine, transported, cut to size and processed according to the application in question.

In a preferred embodiment, in the mat or roll, a magazine rib is connected by material bridges to the adjacent back rib. The material bridges are removed before use. The mats or rolls are cut to size in width, according to the number of holes in the sheet stack to be bound, and the toothed strips are cut off according to the stack thickness.

In a preferred variation, the back rib of the plastic binding element is inserted between the next to the last and the last sheet of the stack, the so-called back sheet. To do this, the back sheet is turned over the first sheet of the stack, the so-called cover sheet, so that the inside of the back sheet comes to rest outside. Then the toothed strips are introduced from the back into the holes of the sheet stack. The loops are closed and the back sheet is turned back.

What is claimed is:

1. A binding element for binding a stack of sheet-shaped print materials, comprising:
a comb structure having a back rib and at least one strip connected to the back rib, wherein the comb structure is inserted through holes in the stack of sheet-shaped print materials and is closable with positive locking in the back rib by the at least one strip, wherein a length of the back rib is adjustable prior to a binding procedure.

2. The binding element according to claim 1, wherein the comb structure is adjustable before the binding procedure to a respective format and thickness of the stack of sheet-shaped print materials.

3. The binding element according to one of claims 1, wherein the strip is a toothed strip.

4. The binding element according to claim 3, wherein for each toothed strip there is an insertion opening in the back rib for the end of the toothed strip bent into a loop and with a locking tooth formed on the back rib for each toothed strip that engages in the teeth of the toothed strip inserted in the insert opening and holds the toothed strip fast.

5. The binding element according to claim 3, wherein the teeth of the toothed strip comprise a ramp that goes up in insertion direction and deflects a locking tooth and has steps behind the ramps, into which the locking tooth falls.

6. The binding element according to claim 5, wherein a stop is provided that limits an insertion depth of the toothed strip.

7. The binding element according to claim 6, wherein the stop is formed on the toothed strip.

8. The binding element according to claim 6, wherein the stop has a distance from the locking tooth that is a multiple of a distance between teeth on the toothed strip.

9. The binding element according to claim 6, wherein the teeth of the toothed strip start behind the stop.

10. The binding element according to claim 1, wherein the at least one strip projects perpendicular from the back rib.

11. The binding element according to claim 1 comprising a plurality of equidistant strips connected to the back rib.

12. The binding element according to claim 1, comprising a plurality of equidistant strips connected to the back rib, and wherein the ends of the strips are connected to a magazine rib parallel to the back rib.

13. The binding element according to claim 12, wherein the magazine rib is connected to an adjacent back rib by material bridges.

14. A method for binding a stack of sheet-shaped print materials, comprising:
inserting a comb structure having a back rib and at least one strip connected to the back rib through holes in the stack of sheet-shaped print materials and closing the comb structure with positive locking in the back rib by the at least one strip, and adjusting a length of the back rib prior to closing the comb structure.

15. The method of claim 14, further comprising adjusting the comb structure before the binding procedure to a respective format and thickness of the stack of sheet-shaped print materials.

16. The method of claim 14, wherein for each strip there is an insertion opening in the back rib for the end of a corresponding strip and further comprising bending the strip and inserting an end thereof into the insertion opening and locking it in place.

17. The method of claim 16, further comprising limiting an insertion depth of the strip with a stop.

18. The method of claim 14, comprising a plurality of parallel strips connected to the back rib.

19. The method of claim 14, comprising a plurality of strips connected to the back rib and wherein for each strip there is an insertion opening in the back rib for the end of a corresponding strip and further comprising bending each strip and inserting an end thereof into each insertion opening and locking it in place.

20. The method of claim 14, further comprising turning over a back sheet of the stack onto a cover sheet of the stack so that its inside comes to lie on the outside, the at least one strip is introduced from the back into the at least one hole, all the loops are closed and the back sheet is turned back.
